(19) United States
(12) Patent Application Publication
(10) Pub. No.: US 2025/0227201 A1
(43) Pub. Date: Jul. 10, 2025

(54) AUDIENCE CONFIGURATIONS OF AUDIOVISUAL SIGNALS

(71) Applicant: Hewlett-Packard Development Company, L.P., Spring, TX (US)

(72) Inventor: Rafael Dal Zotto, Porto Alegre (BR)

(73) Assignee: Hewlett-Packard Development Company, L.P., Spring, TX (US)

(21) Appl. No.: 18/850,927

(22) PCT Filed: Apr. 1, 2022
(86) PCT No.: PCT/US2022/023094

§ 371 Date: Sep. 25, 2024

(51) Int. Cl. H04N 7/14

(52) U.S. Cl. CPC H04N 7/141

(57) ABSTRACT

In some examples, an electronic device includes an image sensor and a controller. The controller receives a first audio-visual signal via the image sensor. The first audiovisual signal depicts multiple audience members. The controller determines regions of the first audiovisual signal that depict the multiple audience members and generates a second audiovisual signal that includes the regions having a specified configuration. The specified configuration is to emulate placement of the audience members within an environment that includes the image sensor. The controller causes display, transmission, or a combination thereof, of the second audiovisual signal.

### BACKGROUND

Electronic devices such as desktops, laptops, notebooks, tablets, and smartphones include executable code that enables users to communicate with users of other electronic devices during events. The participants of an event are referred to herein as an audience. The executable code that enables the audience members to communicate during events (e.g., videoconferencing application, video recording application) enables an audience member to share audio content, video content, or a combination thereof, of the electronic device. The video content may include a real-time video of the audience member and an environment of the electronic device.

### BRIEF DESCRIPTION OF THE DRAWINGS

Various examples are described below referring to the following figures.

FIG. 1 is a block diagram of an electronic device for generating audience configurations of audiovisual signals, in accordance with various examples.

FIG. 2 is a flow diagram of a method for an electronic device for generating audience configurations of audiovisual signals, in accordance with various examples.

FIG. 3 is a block diagram of an electronic device for generating audience configurations of audiovisual signals, in accordance with various examples.

FIG. 4 is a block diagram of an electronic device for generating audience configurations of audiovisual signals, in accordance with various examples.

FIG. 5 is a block diagram of an electronic device for generating audience configurations of audiovisual signals, in accordance with various examples.

FIG. 6 is a block diagram of an electronic device for generating audience configurations of audiovisual signals, in accordance with various examples.

FIG. 7 is a block diagram of an electronic device for generating audience configurations of audiovisual signals, in accordance with various examples.

FIG. 8 is a flow diagram of a method for an electronic device for generating audience configurations of audiovisual signals, in accordance with various examples.

### DETAILED DESCRIPTION

As described above, electronic devices include executable code that enables audience members to share content, to include a real-time video, with other audience members during events. The real-time video is referred to herein as an audiovisual signal. The audiovisual signal includes an audio signal, an image signal, or a combination thereof. The image signal includes multiple frames that are sequential in time to each other. A frame of the image signal includes an image. The image includes a depiction of the environment in which the electronic device is disposed. In some instances, the environment includes multiple audience members. The environment is a conference room, a classroom, a lab, an office, or other suitable meeting place for multiple audience members, for instance. Due to dimensions of the environment, a placement of the image sensor within the environment, a total number of audience members within the environment, or a combination thereof, a view of an audience member of multiple audience members captured by the audiovisual signal may be obscured. Adjusting the placement of the image sensor within the environment may improve the view of the audience member but obscures the view of another audience member of the multiple audience members. Adjusting the placement of the image sensor is disruptive of the event, reducing the audience experience.

To enhance a view of audience members captured by an image sensor within an environment, an electronic device generates and transmits a replacement audiovisual signal that includes enhanced views of the audience members. An enhanced view, as used herein, is a view that generates an increased angle of vision of an audience member, a full profile of the audience member, or a combination thereof. The electronic device analyzes a frame of an audiovisual signal captured by the image sensor to determine whether the frame depicts multiple audience members. An original audiovisual signal, as used herein, is the audiovisual signal captured by the image sensor. For example, the frame of the original audiovisual signal depicts a first audience member having a first angle of vision relative to an optical axis of the image sensor and a second audience member having a second angle of vision relative to the optical axis of the image sensor.

In response to a determination that the frame depicts multiple audience members, the electronic device determines regions for the multiple audience members. A region includes an upper body portion of an audience member. The upper body portion includes shoulders of an audience member, a head of the audience member, or a combination thereof. The electronic device uses post-processing techniques to enhance a view of an audience member within a region. The post-processing techniques adjust an angle of vision of an audience member within a region, adjust an appearance of proximity of the audience member to the image sensor, or a combination thereof, for example. The electronic device generates the replacement audiovisual signal to include the enhanced views of the audience members presented according to a configuration. The configuration is side-by-side, top-bottom, grid-like, a layout that emulates a placement of the multiple audience members within the environment, or a combination thereof, for example. In various examples, in response to detecting movement of an audience member in subsequent frames of the original audiovisual signal, the electronic device adjusts a region associated with the audience member so that the movements of the audience member are captured in the replacement audiovisual signal.

In some examples, the electronic device determines voice prints for the multiple audience members. A voice print, as used herein, is a pattern of voice characteristics that includes a frequency of an audio signal, a duration of the audio signal, an amplitude of the audio signal, or a combination thereof. The electronic device detects lip movements of an audience member of the multiple audience members by analyzing sequential frames of the original audiovisual signal. Based on the lip movements of the audience member, the electronic device determines an audio signal that is associated with the sequential frames of the original audiovisual signal is associated with the audience member having the detected lip movements. The electronic device analyzes the audio signal to generate the voice print associated with the audience member. In various examples, in response to detecting the audience member is speaking and absent from subsequent frames of the original audiovisual signal, the electronic device generates the replacement audiovisual signal to include the region associated with the absent audience member having a static frame of the absent audience member. The electronic device generates the static frame from a previous frame of the replacement audiovisual signal or other suitable image stored to the electronic device, for example.

By enhancing a user view of the multiple audience members, the electronic device enhances the user and the audience experiences because visible and discernable facial expressions of the multiple audience members facilitate communications. By generating the replacement audiovisual signal, the electronic device enhances the user view without disrupting the meeting. By adjusting a region to compensate for audience member movement, the electronic device enhances the user and the audience experiences by facilitating continued communications despite the movement. By generating voice prints for the audience members and replacing a region vacated by an audience member who is speaking out of range of the image sensor with a static image of the audience member, the electronic device facilitates communications by providing the static frame as a reference for the user.

In some examples in accordance with the present description, an electronic device is shown. The electronic device includes an image sensor and a controller. The controller receives a first audiovisual signal via the image sensor. The first audiovisual signal depicts multiple audience members. The controller determines regions of the first audiovisual signal that depict the multiple audience members and generates a second audiovisual signal that includes the regions having a specified configuration. The specified configuration is to emulate placement of the audience members within an environment that includes the image sensor. The controller causes display, transmission, or a combination thereof, of the second audiovisual signal.

In other examples in accordance with the present description, an electronic device is shown. The electronic device includes an image sensor and a controller. In response to a determination that the first frame depicts a first audience member and a second audience member, the controller determines a first region of the first audience member and a second region of the second audience member and generates a second frame that includes the first region and the second region having a specified configuration. The specified configuration is a grid layout. The controller causes display, transmission, or a combination thereof, of the second frame.

In some examples in accordance with the present description, a non-transitory machine-readable medium is shown. The term “non-transitory,” as used herein, does not encompass transitory propagating signals. The non-transitory machine-readable medium stores machine-readable instructions which, when executed by a controller of an electronic device, cause the controller to receive a first audiovisual signal via an image sensor. The first audiovisual signal depicts a first audience member and a second audience member. The first audience member is stationary (e.g., not walking around) and the second audience member is in motion (e.g., walking around). The machine-readable instructions, when executed by the controller, cause the controller to identify regions of the first audiovisual signal that depict the first audience member and the second audience member and generate a second audiovisual signal that includes the regions having a specified configuration. The specified configuration includes a first region depicting the first audience member stationary and a second region depicting the second audience member in motion. The machine-readable instructions, when executed by the controller, cause the controller to cause display, transmission, or a combination thereof, of the second audiovisual signal.

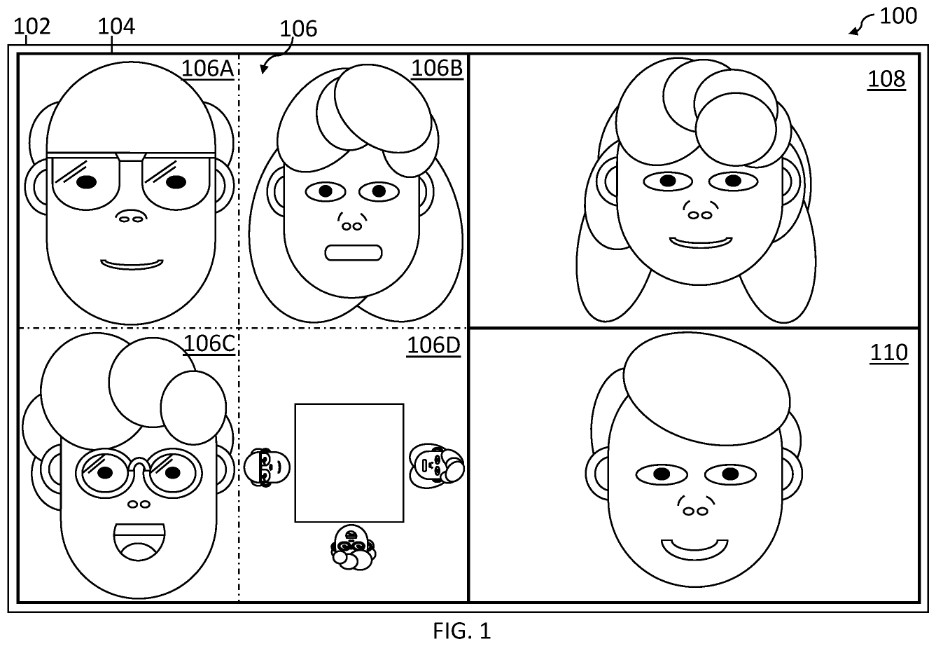

Referring now to FIG. 1, a block diagram of an electronic device 100 for generating audience configurations of audiovisual signals is shown, in accordance with various examples. The electronic device 100 is a desktop, laptop, notebook, tablet, smartphone, or other suitable computing device able to generate audience configurations of audiovisual signals, for example. The electronic device 100 includes a display device 102. The display device 102 is any suitable device for displaying data of the electronic device 100. The display device 102 is a liquid crystal display (LCD), a light-emitting diode (LED) display, a plasma display, or a quantum dot (QD) display, for example.

The display device 102 displays a graphical user interface (GUI) 104. The GUI 104 is a GUI of a videoconferencing application, for example. The GUI 104 depicts images 106, 108, 110. The images 106, 108, 110 are images of audience members within a meeting generated using the videoconferencing application, for example. The images 106, 108, 110 are captured by image sensors of electronic devices in different environments. Utilizing the audiovisual signals received from other electronic devices transmitting during the meeting, the videoconferencing application generates the GUI 104, for example. The GUI 104 includes the images 106, 108, 110 in separate areas of the GUI 104, as indicated by the solid black lines. The separate areas represent an audiovisual signal received from different electronic devices.

An image 106 of audience members in a first environment is captured by an image sensor (not explicitly shown) of the electronic device 100, for example. The image 106 includes regions 106A, 106B, 106C, 106D separated by dashed lines. In some examples, the dashed lines are visible. In other examples, the dashed lines indicate non-visible boundaries of the regions 106A, 106B, 106C, 106D. Slight variations in a background of the regions 106A, 106B, 106C, 106D denote the boundaries, in various examples. A first audience member is depicted in a region 106A, a second audience member is depicted in a region 106B, a third audience member is depicted in a region 106C, and an original audiovisual signal captured by an image sensor of the electronic device 100 is depicted in a region 106D. The regions 106A, 106B, 106C include images of enhanced views of the audience members in the environment of the electronic device 100. An image 108 of an audience member in a second environment is captured by a second image sensor of a second electronic device. The image 108 is received via a network interface that communicatively couples the second electronic device to the electronic device 100, for example. An image 110 of an audience member in a third environment is captured by a third image sensor of a third electronic device. The image 110 is received via a network interface that communicatively couples the third electronic device to the electronic device 100, for example. The image 106 is located in a first area of the GUI 104, the image 108 is located in a second area of the GUI 104, and the image 110 is located in a third area of the GUI 104.

To enhance a view of audience members within the original audiovisual signal depicted in the region 106D, the electronic device 100 generates a replacement audiovisual signal that includes enhanced views of the audience members depicted in the original audiovisual signal. The electronic device analyzes a frame of the original audiovisual signal to determine whether the frame depicts multiple audience members. The electronic device uses facial detection techniques to analyze the frame and determine whether the frame depicts multiple audience members. The facial detection techniques include pre-processing techniques, machine learning techniques, or a combination thereof.

In some examples, the electronic device 100 decomposes the frame of the original audiovisual signal, as shown in the region 106D utilizing a pre-processing technique. Decomposing, as used herein, reduces objects of the image depicted in the frame to edge-like structures. The pre-processing techniques include grayscaling, blurring, sharpening, thresholding, resizing, cropping, or a combination thereof, for example. The electronic device 100 utilizes the facial detection technique to determine whether low intensity regions of the decomposed image include facial features. The facial features include eyebrows, eyes, a nose, lips, hairline, jawline, or a combination thereof, for example.

In other examples, the electronic device 100 utilizes a machine learning technique to detect the facial features. The machine learning technique compares the facial features to multiple templates to determine that the features indicate a face, for example. In some examples, the electronic device 100 utilizes a machine learning technique that implements a convolution neural network (CNN) to determine whether the image includes a face. The CNN is trained with a training set that includes multiple images of multiple faces, for example. The multiple images include faces having different profiles.

In various examples, the electronic device 100 uses a CNN to perform a segmentation technique that decomposes the image by pixel groupings. Using the segmentation technique, the electronic device 100 identifies different objects of the pixel groupings, features of the different objects, boundaries of the different objects, or a combination thereof. The electronic device 100 uses the machine learning technique to determine whether the image includes different body parts (e.g., head, shoulders, arms, torso, legs) to identify an audience member within the image. The machine learning technique uses a CNN trained with a training set that includes multiple images of partial views of bodies, full view of bodies, or a combination thereof, for example.

In response to a determination that the image depicts multiple audience members, the electronic device 100 determines regions for the multiple audience members. In some examples, the electronic device 100 uses a total number of the regions of the replacement audiovisual signal to determine dimensions for a region that depicts an audience member. The total number of regions includes a total number of audience members captured within the replacement audiovisual signal, a region for the original audiovisual signal, or a combination thereof. The greater the total number of regions within the replacement audiovisual signal, the smaller the dimensions for a region that depicts an audience member. The electronic device 100 determines the dimensions using dimensions of the GUI 104 that display the replacement audiovisual signal. For example, in response to the GUI allocating half of the GUI to display the replacement audiovisual signal, the electronic device 100 divides total dimensions of the GUI by two to determine dimensions for display of the replacement audiovisual signal. The electronic device 100 divides the dimensions for the display of the audiovisual signal by the total number of regions to determine dimensions of a region that depicts an audience member, a frame of the original audiovisual signal, or a combination thereof.

In various examples, using the pre-processing techniques, the machine learning techniques, or the combination thereof, the electronic device 100 determines boundaries that encompass coordinates associated with a face of an audience member. In some examples, the electronic device 100 uses the boundaries that encompass the coordinates associated with the audience member as boundaries of a region for the audience member. In other examples, the electronic device 100 adjusts the boundaries to include a neck, shoulders, torso, or a combination thereof, of the audience member. In various examples, the electronic device 100 adjusts the boundaries to form a geometric shape. The geometric shape is a rectangle, a square, a hexagon, or other suitable shape that enables viewing of an upper body of the audience member, for example. In some examples, the shape is a shape of the region that displays the audience member.

The electronic device 100 uses post-processing techniques to enhance a view of an audience member within a region, in various examples. The post-processing techniques adjust an angle of vision of an audience member within the region, adjust an appearance of proximity of the audience member to the image sensor, or a combination thereof, for example. The post-processing techniques include warping a perspective, adjusting a resolution, or a combination thereof. Warping the perspective, as used herein, adjusts an angle of a central axis of an object of interest (e.g., a central axis of a face of the audience member) so that the central axis aligns with an axis of an orthogonal system of a decomposed image, or appears to intersect an optical axis of the image sensor. For example, the electronic device 100 warps the image depicted within the region to generate a full profile of the audience member. Full profile, as used herein, indicates a view of the face of the audience member that includes both eyes of the audience member. A full profile includes three-quarter profiles, for example. Adjusting a resolution, as used herein, includes applying a super resolution to the image of the region to adjust an appearance of proximity of the audience member to the image sensor, to enhance a quality of the appearance, or a combination thereof. By enhancing a user view of the multiple audience members, the electronic device enhances the user and the audience experiences because visible and discernable facial expressions of the multiple audience members facilitate communications.

The electronic device 100 generates the replacement audiovisual signal to include the enhanced views of the audience members presented according to a configuration. The configuration is side-by-side, top-bottom, grid-like, a layout that emulates a placement of the multiple audience members within the environment, or a combination thereof. For example, the electronic device 100 generates the replacement audiovisual signal having the regions 106A, 106B, 106C, 106D in a two-by-two grid configuration. The electronic device 100 generates the replacement audiovisual signal so that the layout of the two-by-two grid configuration depicts the audience members in positions that emulate an audience member's placement in the environment. For example, the region 106A is on a left side of the region 106B to reflect that a first audience member of the region 106D is across a table from a second audience member of the region 106D. The region 106C is below the regions 106A, 106B to reflect that a third audience member is disposed at a third side of the table that is between the first audience member and the second audience member. By generating the replacement audiovisual signal, the electronic device 100 enhances the user view without disrupting the meeting. By including the original audiovisual signal, the electronic device 100 provides additional context for audience members located in different environments from the audience members depicted in the image 106.

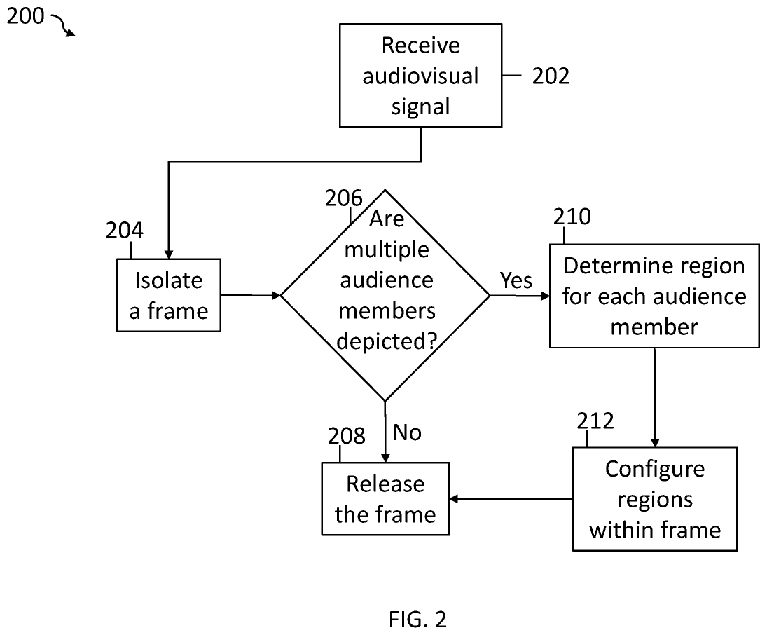

Referring now to FIG. 2, a flow diagram of a method 200 for an electronic device (e.g., the electronic device 100) for generating audience configurations of audiovisual signals is shown, in accordance with various examples. The method 200 includes receiving an audiovisual signal (202). The method 200 also includes isolating a frame of the audiovisual signal (204). Additionally, the method 200 includes determining whether multiple audience members are depicted by an image of the frame (206). In response to a determination that multiple audience members are not depicted by the image, the method 200 includes releasing the frame (208) without adjusting the audiovisual signal. In response to a determination that multiple audience members are depicted in the image, the method 200 includes determining a region for each audience member of the multiple audience members (210). The method 200 also includes configuring the multiple regions within a frame (212). The method 200 includes releasing the frame (208).

In various examples, the method 200 also includes receiving a request by an application to access an image sensor. In response to receiving the request, the method 200 begins receiving the audiovisual signal (202). In some examples, the method 200 includes decomposing an image of the frame of the audiovisual signal, determining whether the image depicts multiple audience members, determining regions for the multiple audience members, configuring the regions within a frame, or a combination thereof, using the techniques described above with respect to FIG. 1.

In some examples, the method 200 includes configuring the regions within the frame of the original audiovisual signal. For example, using an image transforming application, the electronic device intercepts the original audiovisual signal from the image sensor, prior to sharing the original audiovisual signal with the application that requested access to the image sensor. Utilizing the image transforming application, the electronic device enhances the frame of the original audiovisual signal with the regions. The enhanced original audiovisual signal is referred to as a replacement audiovisual signal because the frame including the regions is different than the unenhanced frame of the original audiovisual signal. In other examples, the electronic device replaces the frame of the original audiovisual signal within a buffer utilized for displaying, transmitting, or a combination thereof, with the frame including the regions.

In various examples, the method 200 includes causing a display device (e.g., the display device 102) to display the replacement audiovisual signal. In some examples, the method 200 includes causing, via a network interface of the electronic device, transmission of the replacement audiovisual signal. In other examples, the method 200 includes releasing the frame to the application that requested access to the image sensor. As described above with respect to FIG. 1, the application that requested access to the image sensor, causes a GUI (e.g., the GUI 104) to display the replacement audiovisual signal as well as audiovisual signals received from other electronic devices communicatively coupled to the event hosted by the application.

In some examples, the method 200 includes determining whether the total number of regions is greater than a threshold count. In response to a determination that the total number of regions is equivalent to or less than the threshold count, the method 200 includes determining regions for each audience member of the multiple audience members (210). In response to a determination that the total number of regions is greater than the threshold count, the method 200 includes releasing the frame (208) without generating a replacement audiovisual signal. For example, in response to a determination that dimensions of a region are less than dimensions of the audience member in the original audiovisual signal, the electronic device determines that generating the regions would distract from an effectiveness of communication because the total number of regions would increase a busyness of the GUI without enhancing facial features of the audience members.

In other examples, the method 200 includes determining whether the total number of regions is less than or equivalent to a threshold viewability. In response to a determination that the total number of regions is greater than the threshold visibility, the method 200 includes determining regions for each audience member of the multiple audience members (210). In response to a determination that the total number of regions is less than or equivalent to the threshold viewability, the method 200 includes releasing the frame (208) without generating a replacement audiovisual signal. In various examples, the threshold viewability is based on a number of electronic devices participating in the event. For example, the greater the number of electronic devices participating in the event, the lower a value of the threshold visibility because a lower percentage of the GUI is allocated to each audiovisual signal of an electronic device participating in the event. In other examples, the threshold viewability is based on dimensions of a region associated with the audience member in the original audiovisual signal. For example, the electronic device determines that the regions of the replacement audiovisual signal are within a size range of the regions associated with the audience members in the original audiovisual signal. Because the views of the audience members would not be enhanced above a threshold enhancement, the electronic device determines that the replacement audiovisual signal would not enhance an effectiveness of communication.

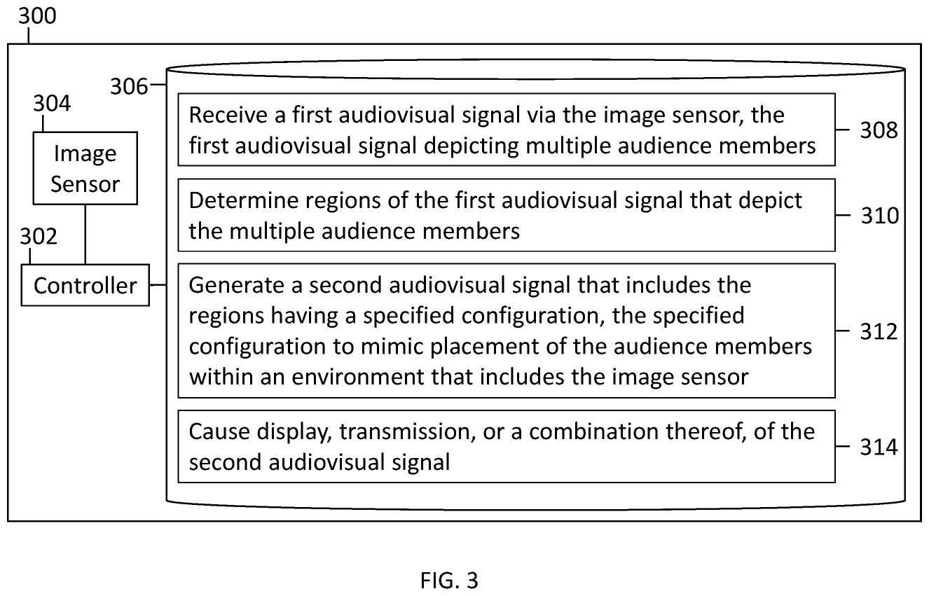

Referring now to FIG. 3, a block diagram of an electronic device 300 for generating audience configurations of audiovisual signals is shown, in accordance with various examples. The electronic device 300 is the electronic device 100, for example. The electronic device 300 includes a controller 302, an image sensor 304, and a storage device 306. The controller 302 is a microcontroller, a microcomputer, a programmable integrated circuit, a programmable gate array, or other suitable device for managing operations of the electronic device 300 or a component or multiple components of the electronic device 300. For example, the controller 302 is a central processing unit (CPU), a graphics processing unit (GPU), or an embedded security controller (EpSC). In another example, the controller 302 is an embedded artificial intelligence (eAI) of the image sensor 304. The image sensor 304 is any suitable device that converts an optical image into an electronic signal (e.g., an image signal, an audiovisual signal). The storage device 306 is a hard drive, a solid-state drive (SSD), flash memory, random access memory (RAM), or other suitable memory for storing data or machine-readable instructions of the electronic device 300.

While not explicitly shown, in some examples, the electronic device 300 includes network interfaces, video adapters, sound cards, local buses, peripheral devices (e.g., a keyboard, a mouse, a touchpad, a speaker, a microphone, a display device), or a combination thereof. While the image sensor 304 is shown as an integrated image sensor of the electronic device 300, in other examples, the image sensor 304 is coupled to the electronic device 300 via a wired (e.g., Universal Serial Bus (USB)) or a wireless (e.g., WI-FI®, BLUETOOTH®) connection. The network interfaces enable communication over a network. The network interfaces may include a wired (e.g., Ethernet, USB) or a wireless (e.g., WI-FI®, BLUETOOTH®) connection, for example. The network is a local area network (LAN), a wide area network (WAN), a virtual private network (VPN), a client/server network, an Internet (e.g., cloud), or any other suitable system for sharing data between electronic devices coupled to the system, for example. In various examples, the controller 302 is coupled to the image sensor 304 and the storage device 306.

In some examples, the storage device 306 stores machine-readable instructions 308, 310, 312, 314, which, when executed by the controller 302, cause the controller 302 to perform some or all of the actions attributed herein to the controller 302. The machine-readable instructions 308, 310, 312, 314, when executed by the controller 302, cause the controller 302 to perform some or all of the method 200, for example.

In various examples, the machine-readable instructions 308, 310, 312, 314, when executed by the controller 302, cause the controller 302 to generate audience configurations of audiovisual signals. The machine-readable instruction 308, when executed by the controller 302, causes the controller 302 to receive a first audiovisual signal via the image sensor 304. The first audiovisual signal depicts multiple audience members, for example. The machine-readable instruction 310, when executed by the controller 302, causes the controller 302 to determine regions of the first audiovisual signal that depict the multiple audience members. The machine-readable instruction 312, when executed by the controller 302, causes the controller 302 to generate a second audiovisual signal that includes the regions having a specified configuration. The specified configuration is to emulate placement of the audience members within the environment that includes the image sensor 304. The machine-readable instruction 314, when executed by the controller 302, causes the controller 302 to cause display, transmission, or a combination thereof, of the second audiovisual signal.

In some examples, the controller 302 determines whether an image of the first audiovisual signal depicts the multiple audience members using the techniques described above with respect to FIG. 1. In response to the determination that the image depicts the multiple audience members, the controller 302 utilizes the techniques described above with respect to FIG. 1 or 2 to determine the regions of the image of the first audiovisual signal that depict the multiple audience members.

As described above, a region includes an upper body portion of an audience member. For example, a region of the regions depicts a face of an audience member of the multiple audience members. A first region depicts a face of a first audience member and a second region depicts a face of a second audience member. In various examples, a region of the regions of the second audiovisual signal depicts the first audiovisual signal. In some examples, the controller 302 modifies a frame of the first audiovisual signal with the regions to generate the second audiovisual signal. For example, as described above with respect to FIG. 2, the controller 302 uses an image transforming application to intercept the first audiovisual signal captured by the image sensor 304. Utilizing the image transforming application, the controller 302 enhances the frame of the original audiovisual signal with the regions. The controller 302 releases the frame of the first audiovisual signal for sharing with the application that requested access to image sensor 304.

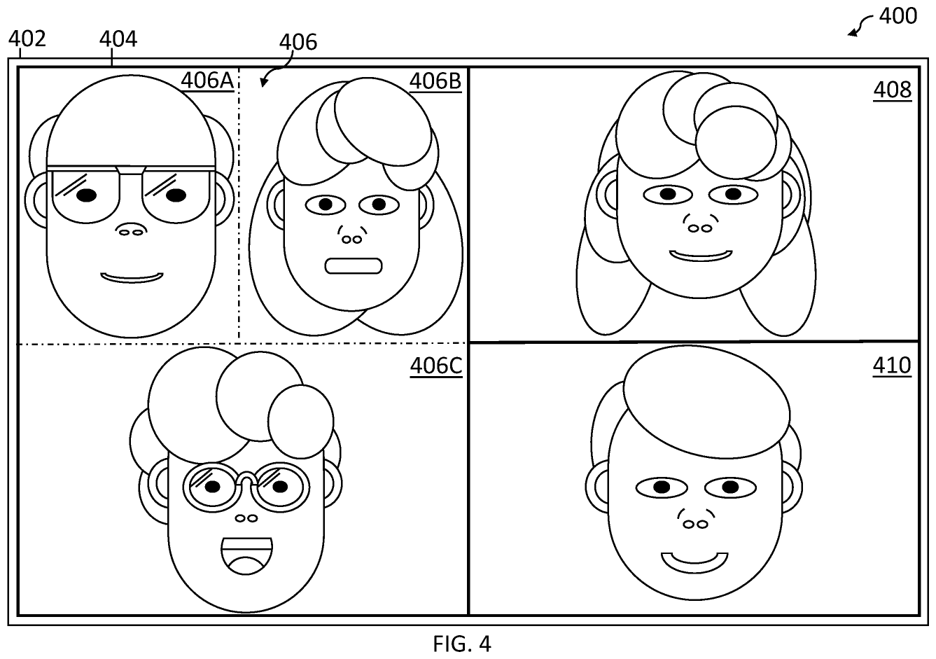

Referring now to FIG. 4, a block diagram of an electronic device 400 for generating audience configurations of audiovisual signals is shown, in accordance with various examples. The electronic device 400 is the electronic device 100, 300, for example. The electronic device 400 includes a display device 402. The display device 402 is the display device 102, for example. The display device 402 displays a GUI 404. The GUI 404 is the GUI 104, for example.

The GUI 404 depicts images 406, 408, 410. The images 406, 408, 410 are images of audience members within a meeting generated using the videoconferencing application, for example. The images 406, 408, 410 are captured by image sensors of electronic devices in different environments. Utilizing the audiovisual signals received from other electronic devices transmitting during the meeting, the videoconferencing application generates the GUI 404, for example. The GUI 404 includes the images 406, 408, 410 in separate areas of the GUI 404, as indicated by the solid black lines. The separate areas represent an audiovisual signal received from different electronic devices.

An image 406 of audience members in a first environment is captured by an image sensor (not explicitly shown) of the electronic device 400, for example. The image 406 includes regions 406A, 406B, 406C. A first audience member is depicted in a region 406A, a second audience member is depicted in a region 406B, and a third audience member is depicted in a region 406C. An image 408 of an audience member in a second environment is captured by a second image sensor of a second electronic device. The image 408 is received via a network interface that communicatively couples the second electronic device to the electronic device 400, for example. An image 410 of an audience member in a third environment is captured by a third image sensor of a third electronic device. The image 410 is received via a network interface that communicatively couples the third electronic device to the electronic device 400, for example. The image 406 is located in a first area of the GUI 404, the image 408 is located in a second area of the GUI 404, and the image 410 is located in a third area of the GUI 404.

As described above with respect to FIG. 3, in various examples, a controller of the electronic device 400 generates audience configurations of audiovisual signals. The controller receives a first audiovisual signal via an image sensor coupled to the electronic device 400, and a second and a third audiovisual signal via a network interface of the electronic device 400. The first audiovisual signal depicts multiple audience members, for example. In some examples, the controller determines whether an image of the first audiovisual signal depicts the multiple audience members using the techniques described above with respect to FIG. 1. The controller determines regions of the first audiovisual signal that depict the multiple audience members. The controller utilizes the techniques described above with respect to FIG. 1 or 2 to determine the regions of the image of the first audiovisual signal that depict the multiple audience members in various examples. The controller generates another audiovisual signal that includes the regions having a specified configuration. The specified configuration emulates placement of the audience members within the environment that includes the image sensor. In some examples, the controller causes display of the second, the third, and the another audiovisual signal within the GUI 404. In other examples, the controller causes transmission, via the network interface of the electronic device 400, of the another audiovisual signal to the second and the third electronic devices.

In some examples, in response to a determination that the image 406 depicts multiple audience members, the electronic device 400 determines regions for the multiple audience members using the techniques described above with respect to FIG. 1. In other examples, the electronic device 400 uses a placement of the audience members within an environment to determine a layout of regions of the image 406. For example, the electronic device 400 determines that a first audience member and a second audience member are in a first row and a third audience member is in second row using distances from the image sensor to the different audience members. In various examples, the electronic device 400 determines the distances between the audience members and the image sensor based on a duration of time from an emission of a signal by the image sensor to receipt of a return signal. In other examples, the electronic device 400 determines the distances to the audience members by comparing dimensions of the audience members depicted within an image to dimensions of fixed objects depicted within the image. In some examples, the electronic device 400 determines the distances to the audience members by utilizing proportional relationships between facial features of the audience members and a characteristic such as focal length of the image sensor.

In various examples, the electronic device 400 compares a number of regions within a row of a layout to determine dimensions for the number of regions within the row. The greater the number of regions within the row of the layout, the smaller the dimensions for a region within the row. The electronic device 400 determines the dimensions using dimensions of the GUI 404 that display the another audiovisual signal. For example, in response to the GUI allocating half of the GUI to display the another audiovisual signal, the electronic device 400 divides total dimensions of the GUI by two to determine dimensions for display of the another audiovisual signal. The electronic device 400 divides the dimensions for the display of the another audiovisual signal by the number of regions within the row to determine the dimensions of the regions within the row. For example, in response to the another audiovisual signal including a first row having three regions and a second row having two regions and the dimensions for the display of the another audiovisual signal being 600 by 800 pixels, the electronic device 400 determines that regions of the first row have dimensions of 200 by 400 pixels and that regions of the second row have dimensions of 300 by 400 pixels.

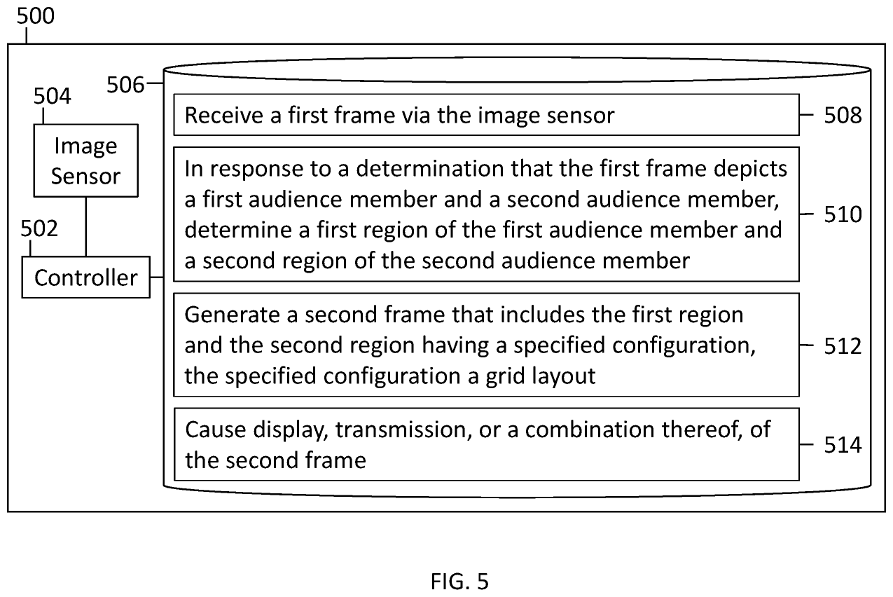

Referring now to FIG. 5, a block diagram of an electronic device 500 for generating audience configurations of audiovisual signals is shown, in accordance with various examples. The electronic device 500 is the electronic device 100, 300, 400, for example. The electronic device 500 includes a controller 502, an image sensor 504, and a storage device 506. The controller 502 is the controller 302, for example. The image sensor 504 is the image sensor 304, for example. The storage device 506 is the storage device 306, for example. In various examples, the controller 502 is coupled to the image sensor 504 and the storage device 506.

In some examples, the storage device 506 stores machine-readable instructions 508, 510, 512, 514, which, when executed by the controller 502, cause the controller 502 to perform some or all of the actions attributed herein to the controller 502. The machine-readable instructions 508, 510, 512, 514, when executed by the controller 502, cause the controller 502 to generate audience configurations of audiovisual signals, for example. The machine-readable instruction 508, when executed by the controller 502, causes the controller 502 to receive a first frame via the image sensor 504. In response to a determination that the first frame depicts a first audience member and a second audience member, the machine-readable instruction 510, when executed by the controller 502, causes the controller 502 to determine a first region of the first audience member and a second region of the second audience member. The machine-readable instruction 512, when executed by the controller 502, causes the controller 502 to generate a second frame that includes the first region and the second region having a specified configuration. The specified configuration is a grid layout, for example. The machine-readable instruction 514, when executed by the controller 502, causes the controller 502 to cause display, transmission, or a combination thereof, of the second frame. In some examples, the second frame is referred to as a replacement frame. The second frame is a frame of a replacement audiovisual signal, for example.

In various examples, the controller 502 determines whether the first frame depicts the multiple audience members using the techniques described above with respect to FIG. 1. In response to the determination that the first frame depicts the multiple audience members, the controller 502 utilizes the techniques described above with respect to FIG. 1 or 2 to determine the regions of the first frame that depict the multiple audience members. In some examples, the controller 502 uses post-processing techniques, as described above with respect to FIG. 1, to generate an enhanced view of the first audience member, the second audience member, or a combination thereof.

In some examples, the first audience member and the second audience member are stationary. Stationary, as used herein, indicates that an audience member stays within a boundary of the region. For example, an audience member who shifts within a seat or moves her head is stationary as long as the audience member is viewable within the boundary of the region. In various examples, the grid layout of the regions emulates placement of the first and the second audience member within the environment that includes the image sensor 504. For example, in response to the first audience member being in a seat across from the second audience member, the controller 502 configures the regions in a side-by-side or a top-bottom grid layout.

In other examples, the first audience member is stationary and the second audience member is in motion. In motion, as used herein, indicates that an audience member moves beyond the boundary of the region. For example, an audience member stands up from a seated position and a face of the audience member is no longer viewable in the region. In some examples, the controller 502 determines that a face of the audience member is no longer detected within the region associated with the audience member using the techniques described above with respect to FIG. 1. In various examples, the controller 502 determines an audience member is in motion by comparing the audience member to another object in the first frame and in a subsequent frame to the first frame. The subsequent frame is a next frame of an audiovisual signal received via the image sensor 504, for example. In other examples, the controller 502 uses a machine learning technique to perform object tracking. For example, the controller 502 uses a computer vision technique, a CNN, or a combination thereof, to compare subsequent frames of the audiovisual signal to determine that the audience member is in motion. In some examples, in response to detecting the audience member in motion, the controller 502 adjusts a region associated with the audience member so that the motion of the audience member is captured in the second frame. In some examples, the controller 502 performs object tracking by tracking a feature within a region. The feature includes facial features, body features, or a combination thereof. The controller 502 compares first coordinates of the feature within the region in a first frame and second coordinates of the feature within the region in a second frame. In response to a determination that the first and the second coordinates differ by a value that is equivalent to or greater than a threshold motion, the controller 502 determines that the audience member is in motion. In other examples, in response to detecting the audience member in motion and outside the region associated with the audience member, the controller 502 causes a static image of the audience member to be displayed within the region associated with the audience member. The static image is stored to the storage device 506, for example.

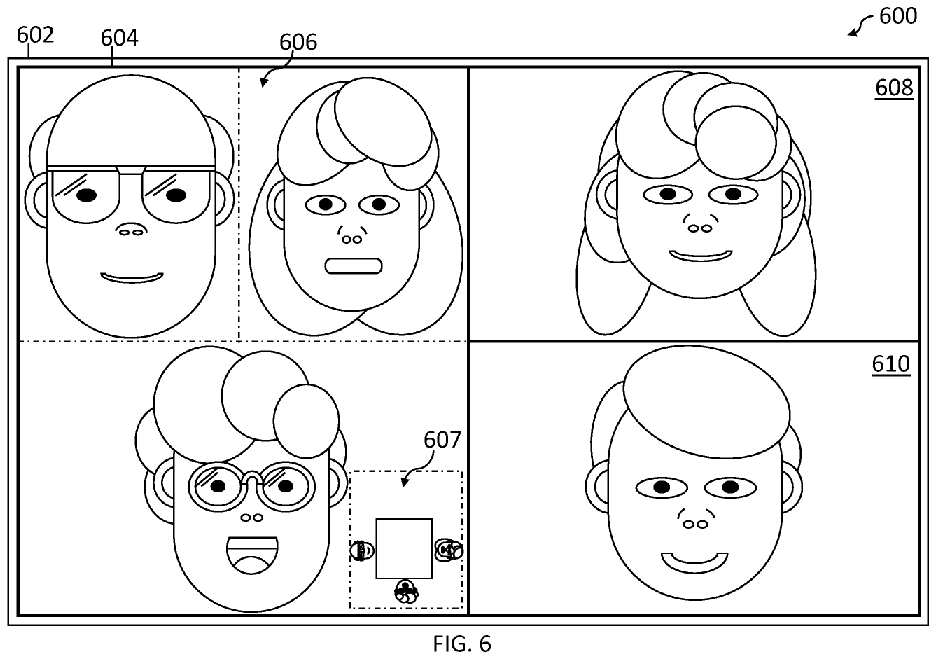

Referring now to FIG. 6, a block diagram of an electronic device 600 for generating audience configurations of audiovisual signals is shown, in accordance with various examples. The electronic device 600 is the electronic device 100, 300, 400, 500, for example. The electronic device 600 includes a display device 602. The display device 602 is the display device 102, 402, for example. The display device 602 displays a GUI 604. The GUI 604 is the GUI 104, 404, for example.

The GUI 604 depicts images 606, 608, 610. The images 606, 608, 610 are images of audience members within a meeting generated using the videoconferencing application, for example. The images 606, 608, 610 are captured by image sensors of electronic devices in different environments. Utilizing the audiovisual signals received from other electronic devices transmitting during the meeting, the videoconferencing application generates the GUI 604, for example. The GUI 604 includes the images 606, 608, 610 in separate areas of the GUI 604, as indicated by the solid black lines. The separate areas represent an audiovisual signal received from different electronic devices.

An image 606 of audience members in a first environment is captured by the image sensor (not explicitly shown) of the electronic device 600, for example. The image 606 includes multiple regions that depict a first audience member, a second audience member, and a third audience member and an image 607. The image 607 is an image of audience members captured by an image sensor of the electronic device 600, for example. An image 608 of an audience member in a second environment is captured by a second image sensor of a second electronic device. The image 608 is received via a network interface that communicatively couples the second electronic device to the electronic device 600, for example. An image 610 of an audience member in a third environment is captured by a third image sensor of a third electronic device. The image 610 is received via a network interface that communicatively couples the third electronic device to the electronic device 600, for example. The image 606 is located in a first area of the GUI 604, the image 608 is located in a second area of the GUI 604, and the image 610 is located in a third area of the GUI 604.

As described above with respect to FIG. 4, the electronic device 600 uses a placement of the audience members within an environment to determine a layout of the regions within the image 606. For example, the electronic device 600 determines that a first audience member and a second audience member are in a first row and a third member is in second row using distances from the image sensor to the different audience members. The electronic device 600 determines the distances using the techniques described above with respect to FIG. 4, for example. In various examples, the electronic device 600 compares a number of regions within a row of a layout to determine dimensions for the number of regions within the row, as described above with respect to FIG. 4. In some examples, the electronic device 600 determines a placement of the image 607 by determining a region that has dimensions greater than a threshold dimension. In other examples, the electronic device 600 determines the placement of the image 607 by determining which region of the multiple regions has a greatest dimension.

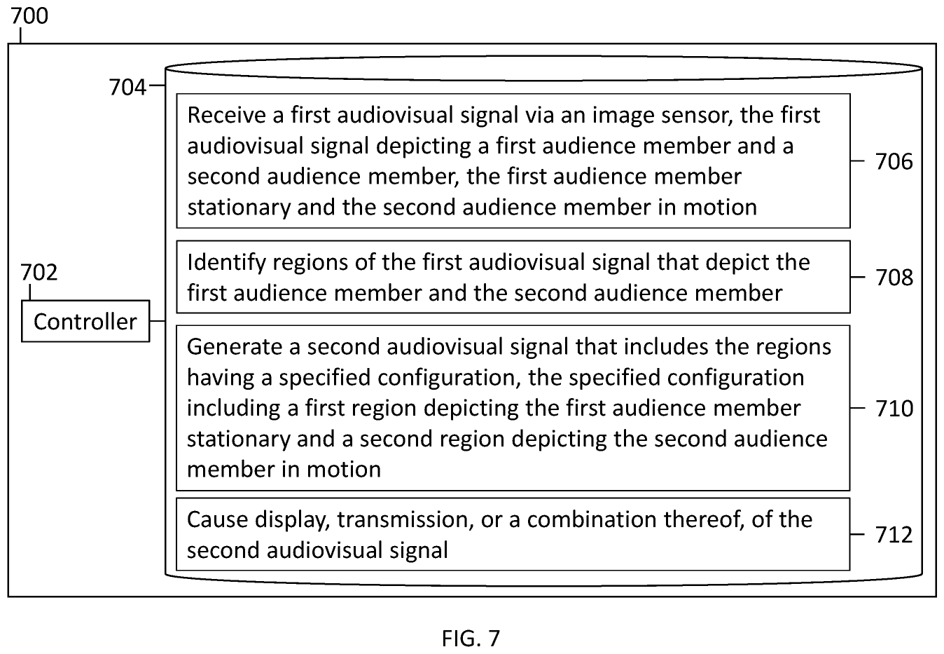

Referring now to FIG. 7, a block diagram depicting an electronic device 700 for generating audience configurations for audiovisual signals is shown, in accordance with various examples. The electronic device 700 is the electronic device 100, 300, 400, 500, 600, for example. The electronic device 700 includes a controller 702 and a non-transitory machine-readable medium 704. The controller 702 is the controller 302, 502, for example. The non-transitory machine-readable medium 704 is the storage device 306, 506, for example. In various examples, the controller 702 is coupled to the non-transitory machine-readable medium 704.

In some examples, the non-transitory machine-readable medium 704 stores machine-readable instructions 706, 708, 710, 712, which, when executed by the controller 702, cause the controller 702 to perform some or all of the actions attributed herein to the controller 702. The machine-readable instructions 706, 708, 710, 712, when executed by the controller 702, cause the controller 702 to generate audience configurations of audiovisual signals, for example.

In various examples, the machine-readable instruction 706, when executed by the controller 702, causes the controller 702 to receive a first audiovisual signal via an image sensor (e.g., the image sensor 304, 504). The first audiovisual signal depicts a first audience member and a second audience member. The first audience member is stationary and the second audience member is in motion. The machine-readable instruction 708, when executed by the controller 702, causes the controller 702 to identify regions of the first audiovisual signal that depict the first audience member and the second audience member. The machine-readable instruction 710, when executed by the controller 702, causes the controller 702 to generate a second audiovisual signal that includes the regions having a specified configuration. The specified configuration includes a first region depicting the first audience member stationary and a second region depicting the second audience member in motion. The machine-readable instruction 712, when executed by the controller 702, causes the controller 702 to cause display, transmission, or a combination thereof, of the second audiovisual signal.

In some examples, the controller 702 determines that the first audiovisual signal depicts the first and the second audience members, determines regions for the first and the second audience members, generates the second audiovisual signal, or a combination thereof, using the techniques described above with respect to FIG. 1. In various examples, the controller 702 determines that the first audience member is speaking. The controller 702 uses techniques described above with respect to FIG. 1 or 5 to detect lip movements of an audience member of the multiple audience members by analyzing sequential frames of the first audiovisual signal, for example. The controller 702 generates a voice print for the first audience member. The controller 702 uses voice biometric techniques to process an audio signal of the audiovisual signal to identify a frequency of the audio signal, a duration of the audio signal, an amplitude of the audio signal, or a combination thereof. Based on the lip movements of the audience member, the controller 702 determines the audio signal that is associated with the sequential frames of the first audiovisual signal is associated with the audience member having the detected lip movements. The controller 702 analyzes the audio signal to generate the voice print associated with the audience member. The controller 702 associates the voice print with the first region.

In other examples, the controller 702 determines that the second audience member is speaking. The controller 702 generates a second voice print for the second audience member. The controller 702 associates the second voice print with the second region. In some examples, the controller 702 determines that the second audience member is speaking. The controller 702 populates the second region with a static image of the second audience member in response to a determination that the second audience member is outside a field of view of the image sensor. The controller 702 generates the static frame from a previous frame of the second audiovisual signal, for example. In another example, the controller 702 generates the static frame from a profile of the user stored to the non-transitory machine-readable medium 704. In another example, the controller 702 generates the static frame by selecting from a set of default avatars stored to the non-transitory machine-readable medium 704. In some examples, a region of the regions includes a marker to indicate an audience member depicted within the region is speaking. The marker is a highlighted border, an icon within the region, text within the region, or other suitable indicator, for example.

In various examples, the controller 702 determines that the first audience member is in motion. The controller 702 uses the techniques described above with respect to FIG. 5, for example. The controller 702 generates the second audiovisual signal that includes the regions having a specified configuration. The specified configuration includes the first region depicting the first audience member in motion. The controller 702 uses post-processing techniques to increase an angle of vision of an audience member, a full profile of the audience member, or a combination thereof, as described above with respect to FIG. 1, for example. The controller 702 causes the display, the transmission, or the combination thereof, of the second audiovisual signal.

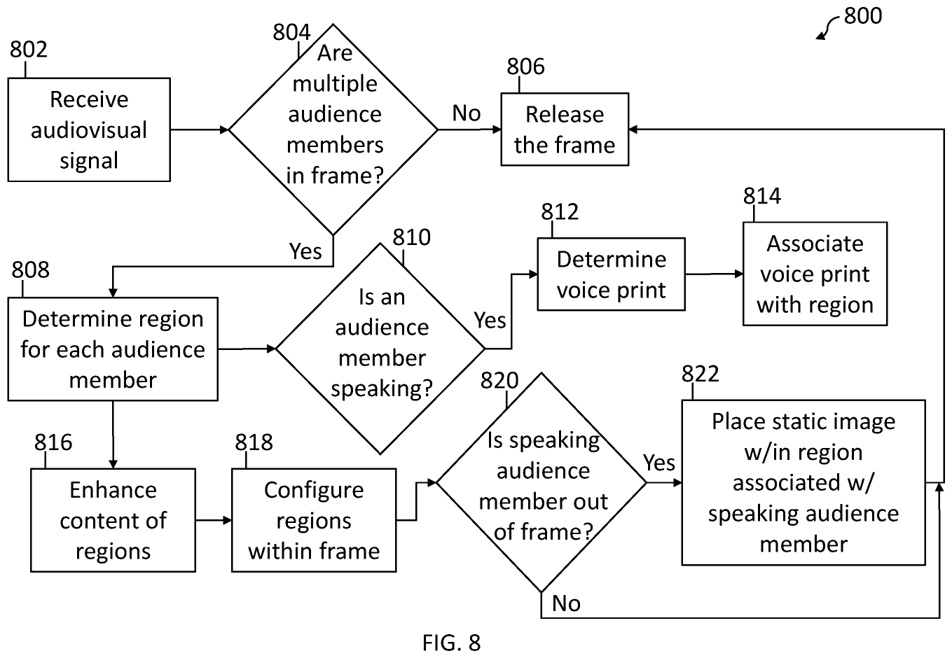

Referring now to FIG. 8, a flow diagram of a method 800 for an electronic device (e.g., the electronic device 100, 300, 400, 500, 600, 700) for generating audience configurations of audiovisual signals, in accordance with various examples. The method 800 includes receiving an audiovisual signal (802). The method 800 also includes determining whether multiple audience members are depicted by an image of a frame of the audiovisual signal (804). Additionally, in response to a determination that the image does not include multiple audience members, the method 800 includes releasing the frame (806). In response to a determination that the image does include the multiple audience members, the method 800 also includes determining regions for each audience member of the multiple audience members (808).

The method 800 includes determining whether an audience member is speaking (810). In response to a determination that the audience member is speaking, the method 800 includes determining a voice print for the audience member (812). Additionally, the method 800 includes associating the voice print with the region that includes the audience member (814).

The method 800 also includes enhancing an image of an audience member within a region (816). Additionally, the method 800 includes configuring the regions within a frame (818). The method 800 includes determining whether an audience member who is speaking is not shown within the frame (820). In response to a determination that the audience member who is speaking is shown in the frame, the method 800 includes releasing the frame (806). In response to a determination that the audience member who is speaking is not shown within the frame, the method 800 includes placing a static image within the region associated with the audience member who is speaking (822). The method 800 includes releasing the frame (806).

In some examples, in response to a determination that an audience member who is speaking is not associated with a region of the frame, the method 800 includes generating another region and placing a static image within the region. The static image is an image of the audience member from a previous frame, a generic image, an avatar, text, or other suitable representation for the audience member. In various example, the method 800 includes generating a data structure that includes a region, an identifier for an audience member, a voiceprint for the audience member, a static image to represent the audience member, or a combination thereof. The data structure is stored to a storage device (e.g., the storage device 306, 506, the non-transitory machine-readable medium 704) of the electronic device.

As described above with respect to FIG. 2, in various examples, in response to a determination that a total number of regions is greater than the threshold count, the method 800 includes determining that generating the regions would distract from an effectiveness of communication because the total number of regions would increase a busyness of a GUI (e.g., the GUI 104, 404, 604) displaying the audiovisual signal including the regions without enhancing facial features of the audience members. The method 800 includes generating regions for audience members who are speaking, who have spoken within a time range, within a speaker indicator threshold, or a combination thereof. For example, the method 800 includes generating regions for audience members who have spoken within the most recent time range (e.g., 5 minutes, 10 minutes, 12 minutes, or other suitable time range). In another example, the method 800 includes generating regions for the most recent number of audience members who have spoken, where the most recent number of audience members is determined by the speaker indicator threshold. In various examples, the method 800 includes generating the regions for the audience members who are speaking, who have spoken within a time range, whose turn to speak occurred within a speaker indicator threshold, or a combination thereof, in addition to a region that includes the original audiovisual signal. In some examples, the configuration of the regions for the audience members who are speaking indicate an order in which an audience member has spoken. For example, a region associated with an audience member who is currently speaking is at a first grid position and a region associated with an audience member who spoke immediately before the currently speaking audience member is at a second grid position that is to the right or below the first grid position.

By generating a limited number of regions based on a specified criteria, the electronic device utilizing the method 800 enhances an effectiveness of communication by enhancing facial features of audience members who are speaking, who have recently spoken, or a combination thereof.

By enhancing a user view of the multiple audience members, the electronic device enhances the user and the audience experiences because visible and discernable facial expressions of the multiple audience members facilitate communications. By generating the replacement audiovisual signal, the electronic device enhances the user view without disrupting the meeting. By adjusting a region to compensate for audience member movement, the electronic device enhances the user and the audience experiences by facilitating continued communications despite the movement. By generating voice prints for the audience members and replacing a region vacated by an audience member who is speaking out of range of the image sensor with a static image of the audience member, the electronic device facilitates communications by providing the static frame as a reference for the user.

Unless infeasible, some or all of the method 200, 800 is performed by a controller (e.g., the controller 302, 502, 702) concurrently or in different sequences and by circuity of an electronic device (e.g., the electronic device 100, 300, 400, 500, 600, 700), execution of machine-readable instructions of the electronic device, or a combination thereof. For example, the method 200, 800 is implemented by machine-readable instructions stored to a storage device (e.g., the storage device 306, 506, the non-transitory machine-readable medium 704, or another storage device not explicitly shown of the electronic device), circuitry (some of which is not explicitly shown) of the electronic device, or a combination thereof. The controller executes the machine-readable instructions to perform some or all of the method 200, 800, for example.

In some examples, utilizing a GUI (e.g., the GUI 104, 404, 604), an audience member specifies the thresholds, the ranges, or a combination thereof, used by an electronic device (e.g., the electronic device 100, 300, 400, 500, 600, 700) for generating audience configurations of audiovisual signals. For example, the user specifies the threshold count, time range, speaker indicator threshold, threshold distance, threshold dimension, threshold viewability, size range, threshold enhancement, threshold motion, or a combination thereof. In various examples, the GUI enables the audience member to specify whether to include a frame from an original audiovisual signal within the replacement audiovisual signal. In other examples, the GUI enables the audience member to specify the configuration of the audience members within the audiovisual signals. For example, the GUI enables the audience member to select a side-by-side configuration, a top-bottom configuration, a grid-like configuration, or to specify another layout that emulates a placement of multiple audience members within the environment. In other examples, a manufacturer of the electronic device specifies the thresholds, the ranges, or the combination thereof. In various examples, the electronic device uses machine learning techniques to determine the thresholds, the ranges, or the combination thereof. Based on different selections of GUI options that are made by the audience member, the electronic device uses machine learning techniques to adjust the thresholds, the ranges, or the combination thereof, specified by the manufacturer, for example.

While some components are shown as separate components of the electronic device 300, 500, 700, in other examples, the separate components are integrated in a single package. For example, the storage device 306, 506, is integrated with the controller 302, 502, respectively. The single package may herein be referred to as an integrated circuit (IC) or an integrated chip (IC).

The above description is meant to be illustrative of the principles and various examples of the present description. Numerous variations and modifications become apparent to those skilled in the art once the above description is fully appreciated. It is intended that the following claims be interpreted to embrace all such variations and modifications.

In the figures, certain features and components disclosed herein are shown in exaggerated scale or in somewhat schematic form, and some details of certain elements are not shown in the interest of clarity and conciseness. In some of the figures, in order to improve clarity and conciseness, a component or an aspect of a component are omitted.

In the above description and in the claims, the term “comprising” is used in an open-ended fashion, and thus should be interpreted to mean “including, but not limited to . . . ” Also, the term “couple” or “couples” is intended to be broad enough to encompass both direct and indirect connections. Thus, if a first device couples to a second device, that connection may be through a direct connection or through an indirect connection via other devices, components, and connections. Additionally, the word “or” is used in an inclusive manner. For example, “A or B” means any of the following: “A” alone, “B” alone, or both “A” and “B.”

What is claimed is:

1. An electronic device, comprising:
an image sensor; and
a controller to:
receive a first audiovisual signal via the image sensor, the first audiovisual signal depicting multiple audience members;
determine regions of the first audiovisual signal that depict the multiple audience members;
generate a second audiovisual signal that includes the regions having a specified configuration, the specified configuration to emulate placement of the audience members within an environment that includes the image sensor; and
cause display, transmission, or a combination thereof, of the second audiovisual signal.

2. The electronic device of claim 1, wherein a region of the regions depicts a face of an audience member of the multiple audience members.

3. The electronic device of claim 1, wherein a region of the regions includes a marker to indicate an audience member depicted within the region is speaking.

4. The electronic device of claim 1, wherein the controller is to enhance a frame of the first audiovisual signal with the regions to generate the second audiovisual signal.

5. The electronic device of claim 1, wherein a region of the regions of the second audiovisual signal depicts the first audiovisual signal.

6. An electronic device, comprising:
an image sensor; and
a controller to:
receive a first frame via the image sensor;
in response to a determination that the first frame depicts a first audience member and a second audience member, determine a first region of the first audience member and a second region of the second audience member;
generate a second frame that includes the first region and the second region having a specified configuration, the specified configuration a grid layout; and
cause display, transmission, or a combination thereof, of the second frame.

7. The electronic device of claim 6, wherein the first audience member and the second audience member are stationary.

8. The electronic device of claim 6, wherein the first audience member is stationary and the second audience member is in motion.

9. The electronic device of claim 6, wherein the grid layout emulates placement of the first and the second audience members within an environment that includes the image sensor.

10. The electronic device of claim 6, wherein the controller is to use post-processing techniques to generate an enhanced view of the first audience member, the second audience member, or a combination thereof.

11. A non-transitory machine-readable medium storing machine-readable instructions which, when executed by a controller of an electronic device, cause the controller to:
receive a first audiovisual signal via an image sensor, the first audiovisual signal depicting a first audience member and a second audience member, the first audience member stationary and the second audience member in motion;
identify regions of the first audiovisual signal that depict the first audience member and the second audience member;
generate a second audiovisual signal that includes the regions having a specified configuration, the specified configuration including a first region depicting the first audience member stationary and a second region depicting the second audience member in motion; and
cause display, transmission, or a combination thereof, of the second audiovisual signal.

12. The non-transitory machine-readable medium of claim 11, wherein the controller is to:
determine that the first audience member is speaking;
generate a voice print for the first audience member; and
associate the voice print with the first region.

13. The non-transitory machine-readable medium of claim 12, wherein the controller is to:
determine that the second audience member is speaking;
generate a second voice print for the second audience member; and
associate the second voice print with the second region.

14. The non-transitory machine-readable medium of claim 12, wherein the controller is to:
determine that the second audience member is speaking; and
populate the second region with a static image of the second audience member in response to a determination that the second audience member is outside a field of view of the image sensor.

15. The non-transitory machine-readable medium of claim 11, wherein the controller is to:
determine that the first audience member is in motion;
generate the second audiovisual signal that includes the regions having the specified configuration, the specified configuration including the first region depicting the first audience member in motion;
use post-processing techniques to increase an angle of vision of an audience member, a full profile of the audience member, or a combination thereof; and
cause the display, the transmission, or the combination thereof, of the second audiovisual signal.
